(19) United States
(12) Patent Application Publication
(10) Pub. No.: US 2020/0023530 A1
(43) Pub. Date: Jan. 23, 2020

(54) REPLACEABLE RAZOR CARTRIDGE COMPONENT

(71) Applicant: Société BIC, Clichy Cedex (FR)

(72) Inventor: Steven A. BURKHART, Woodbridge, CT (US)

(21) Appl. No.: 16/512,868

(22) Filed: Jul. 16, 2019

Related U.S. Application Data
(60) Provisional application No. 62/699,954, filed on Jul. 18, 2018.

(51) Int. Cl. B26B 21/44; B26B 21/40; B26B 21/52

(52) U.S. Cl. CPC B26B 21/443; B26B 21/222; B26B 21/52; B26B 21/4012

(57) ABSTRACT

A razor cartridge may include a housing having a top surface, a bottom surface, a first side wall, and a second side wall. The cartridge may also include one or more blades disposed within the housing. A groove may extend along or parallel to a longitudinal axis of the razor cartridge, and the groove may be located on the top surface, extending between the first side wall and the second side wall and traversing one or more of the first side wall and the second side wall. A shaving aid strip may be configured to releasably couple with the groove by sliding the shaving aid strip into and out of the groove.

### CROSS REFERENCE TO RELATED APPLICATION

This application claims priority to U.S. Provisional Application No. 62/699,954, filed on Jul. 18, 2018, the entirety of which is incorporated herein by reference.

### FIELD

The present disclosure relates to razor cartridges comprising replaceable components, e.g., shaving aid strips, that are connected releasably with the cartridges. The disclosure further relates to shavers comprising such cartridges.

### BACKGROUND ART

Shavers generally include a handle and a razor cartridge fixedly or releasably attached to the handle. The razor cartridge includes at least one blade for shaving hair. The razor cartridge may also include a shaving aid strip, usually a lubricating or moisturizing strip, extending parallel to at least one blade. The user holds the handle and repeatedly moves the razor across an area of the body to be shaved, e.g., the face, until hair is removed from the surface of the body. The shaving aid strip may function to decrease or prevent skin irritation due to the repeated exposure of the skin to sharp razor blades. In some instances, however, as the shaver is used over time, the shaving aid strip, e.g., lubricating or moisturizing strip, may become worn at a faster rate than the blades. This may result in a decrease in the functionality of the strip prior to the blades of the razor cartridge becoming dull, thereby effectively shortening the useful life of the razor cartridge.

Both the foregoing general description and the following detailed description are exemplary and explanatory only and are not restrictive of the features, as claimed. As used herein, the terms “comprises,” “comprising,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. Moreover, in the claims, values, limits, and/or ranges mean the value, limit, and/or range+/−10%.

### BRIEF DESCRIPTION OF THE FIGURES

The accompanying drawings, which are incorporated in and constitute a part of this specification, illustrate the disclosed embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. In the drawings:

FIG. 1 depicts a shaver, according to various aspects of the present disclosure.

FIG. 2A provides a partial side view of the shaver of FIG. 1, according to various aspects of the present disclosure.

FIG. 2B depicts an exploded, cross-sectional view of a shaving aid strip embedded in the housing of the razor cartridge of the shaver depicted in FIG. 2A.

FIG. 2C depicts a cross-sectional view (B) of the shaving aid strip of FIG. 2B.

FIG. 2D depicts a length of the shaving aid strip (C) of FIGS. 2B and 2C.

FIG. 2E depicts an alternative exploded, cross-sectional view of a shaving aid strip embedded in the housing of the razor cartridge of the shaver depicted in FIG. 2A.

FIG. 3 depicts a shaving aid adhesive strip (applied as sticky tape) on the housing of the razor cartridge of the shaver of FIG. 1.

FIG. 4 depicts a shaver having a storage compartment in the handle, according to various aspects of the present disclosure.

### DETAILED DESCRIPTION

Reference will now be made in detail to the exemplary embodiments of the present disclosure described below and illustrated in the accompanying drawings. Wherever possible, the same reference numbers will be used throughout the drawings to refer to same or like parts.

Additional objects and advantages of the embodiments will be set forth in part in the description that follows, and in part will be obvious from the description, or may be learned by practice of the embodiments. It is to be understood that both the foregoing general description and the following detailed description are exemplary and explanatory only and are not restrictive of the claims.

Many razor cartridges currently include one or more razor blades and a shaving aid such as, for example, a lubricating or moisturizing component. The lubricating or moisturizing component may be a shaving aid strip that is capable of providing moisture and/or lubrication during shaving. Typically, shaving aid strips are provided integrally with the razor cartridge. In some instances, the shaving aid strip, provided as part of a razor cartridge, may wear at a higher rate than the metal blades of the cartridge. As a result, customers may not benefit from the full use of the razor cartridge, because they may discard a razor cartridge once they notice the shaving aid strip wearing down, even though the metal blades are not yet dull. Alternatively, customers may continue using the razor cartridge beyond the point of wear of the shaving aid strip—since the blades may not yet be dull—which may reduce the overall shaving performance, because the worn shaving aid strip may no longer provide adequate moisture or lubrication. Accordingly, a shaving aid strip may not be able to maintain its lubricating or moisturizing effect, or otherwise facilitate shaving, for long enough to match the usable life of the blades, thus leading to a suboptimal shaving experience.

The ability to replace a shaving aid strip (entirely or partially) located within a razor cartridge one or more times before the user disposes of the razor cartridge or shaver may encourage the user to use the razor cartridge and/or shaver for a longer period of time, until the blades become dull. This may promote environmentally friendly use of a shaver and/or may promote personalization and customization of the shaver, as will be described in detail below.

Embodiments of the present disclosure may be drawn to a shaving aid strip that is a replaceable shaving aid strip to encourage a user to continue using a razor cartridge for the full lifetime of the razor blades. This may create a more efficient and enjoyable shaving experience for the users. For example, aspects of the present disclosure are drawn to razor cartridges with grooves configured to receive one or more shaving aid strips within the grooves. The replaceable shaving aid strips may be configured to slide into and out of the grooves of the housing of the razor cartridges for removal and replacement. Accordingly, the users may be able to replace a shaving aid strip of a razor cartridge one or more times before disposing of the razor cartridge or shaver. It is noted that in this disclosure, the term “shaving aid strip” is used to refer to replaceable strips generally and is not limited to strips specifically intended to be used for lubrication and/or moisturizing. Indeed, embodiments of the present disclosure are directed to a number of various shaving aid strips designed and intended for a variety of functions related to skin care and shaving, as will be described further below.

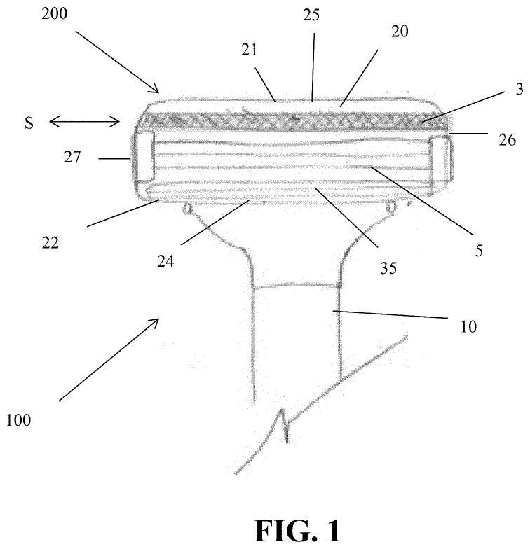

FIG. 1 depicts a shaver 100. The shaver 100 includes a handle 10 and a razor cartridge 200 having at least one blade 5 and at least one shaving aid strip, such as, for example, a shaving aid strip 3. The razor cartridge 200 may be permanently or releasably secured to handle 10, and the shaving aid strip 3 may be removably coupled with the housing 20 of the razor cartridge 200. Although only one shaving aid strip 3 is depicted in FIG. 1, it is contemplated that more than one shaving aid strip may be included in the razor cartridge 200. For example, one or more shaving aid strips 3 may be located at the trailing portion 21 of the razor cartridge 200. Alternatively, one or more shaving aid strips 3 may be located at the leading portion 22 of the razor cartridge 200, or one or more shaving aid strips 3 may be located at both leading portion 22 and trailing portion 21 of the razor cartridge 200.

The shaving aid strip 3 may be releasably coupled with any suitably-configured portion of the housing 20 of the razor cartridge 200. The razor cartridge 200 may comprise a housing 20 having a top surface and a bottom surface, opposite the top surface, wherein the top surface is configured to come in contact with the skin. The housing 20 may further be defined by a front longitudinal wall 24, a rear longitudinal wall 25, a first side wall 26, and a second side wall 27. The razor cartridge 200 may further comprise one or more blades 5 disposed within the housing 20.

The razor cartridge 200 may further comprise a groove 7 comprising an upper longitudinal wall 30 and a lower longitudinal wall 31, both being parallel to the front longitudinal wall 24 and the rear longitudinal wall 25 of the housing 20. The groove 7 may be located on the top surface of the housing 20 between the first side wall 26 and the second side wall 27. Particularly, the groove 7 may extend longitudinally (i.e., parallel to one or more blades 5) across the top surface of the housing 20 of the razor cartridge 200 for receiving the shaving aid strip 3 and may traverse one or more of the first side wall 26 and the second side wall 27 of the housing 20. In other words, the groove 7 may be accessible from a first side wall 26 of the housing 20 of the razor cartridge 200 and a second side wall 27 of the housing 20 of the razor cartridge 200. In some examples, the groove 7 may extend through and be accessible via the first side wall 26 of the housing 20 of the razor cartridge 200 and may extend longitudinally across the top surface of the housing 20 of the razor cartridge 200, but it may terminate before reaching the second side wall 27 of the housing 20 of the razor cartridge 200. In such an example, the groove 7 may only be accessible from the first side wall 26 of the housing 20 of the razor cartridge 200.

In some examples, the shaving aid strip 3 may be releasably coupled with the groove 7. The shaving aid strip 3 may be configured to be coupled with the groove 7 by sliding into and out of the groove 7. In some examples, the shaving aid strip 3 may extend along or parallel to a longitudinal axis of the razor cartridge 200. In some examples, the shaving aid strip 3 may extend parallel to one or more blades 5 either on a leading portion 22 of the razor cartridge 200 or a trailing portion 21 of the razor cartridge 200, or both. The shaving aid strip 3 may be included within or adjacent to a guard bar 35 of the razor cartridge 200 or may be spaced apart from the guard bar 35. For example, the shaving aid strip 3 may be located in any position distant from the guard bar 35 that provides sufficient surface for the shaving aid strip 3 to be disposed longitudinally. The guard bar 35 may be located between the first and second side walls 26, 27 of the housing 20.

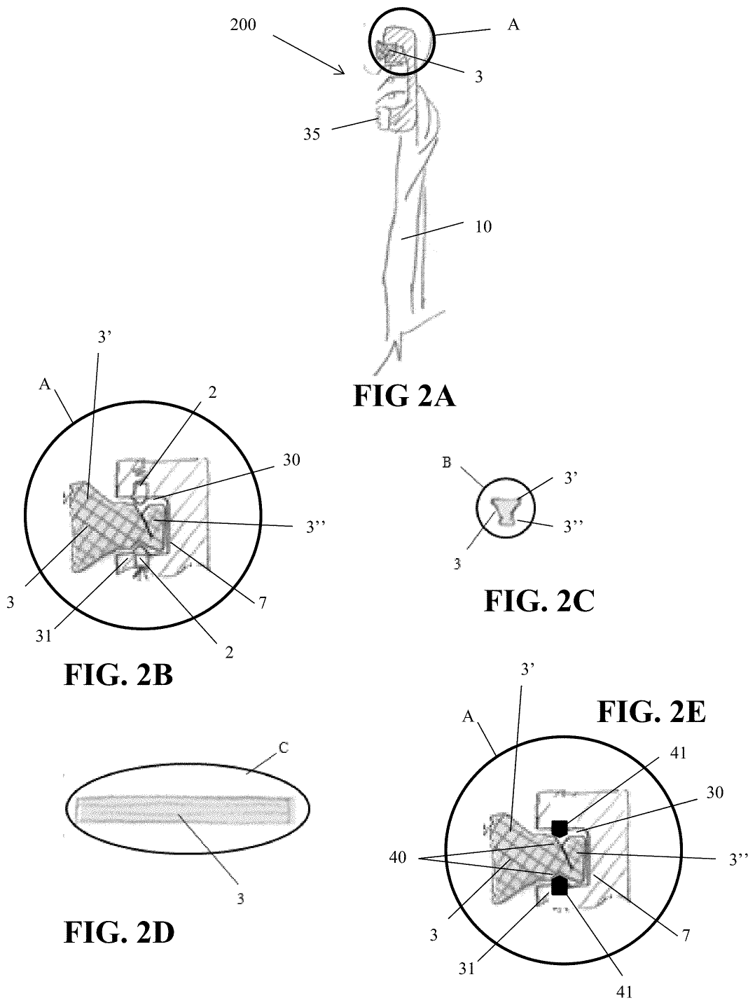

FIGS. 2A through 2C depict how the shaving aid strip 3 may be coupled with the housing 20 of the razor cartridge 200 by being incorporated within the groove 7, in order to allow for removal and replacement of the shaving aid strip 3 from the razor cartridge 200. As shown in FIG. 2B, the shaving aid strip 3 may include an upper portion 3′ configured to contact the skin of a user. The upper portion 3′ may be visible to the user when the shaving aid strip 3 is coupled with the housing 20 of the razor cartridge 200 by being incorporated within the groove 7. The upper portion 3′ of the shaving aid strip 3 may lie flush with or may protrude from the top surface of the upper longitudinal wall 30 and/or from the top surface of the lower longitudinal wall 31 of the groove 7. A side profile (B) of a shaving aid strip 3 is depicted in FIG. 2C, and a length (C) of the shaving aid strip 3 is depicted in FIG. 2D. It is contemplated, however, that the shaving aid strip 3 may have any suitable cross-sectional shape, depending on the shape of the groove 7 into which the shaving aid 3 is configured to be disposed. Additionally, the upper portion 3′ of the shaving aid strip 3 may be configured in any suitable shape (e.g., rounded, flat, tapered, sloped) to allow the shaving aid strip 3 to protrude more or less from the top surface of the housing 20 of the razor cartridge 200 when the shaving aid strip 3 is attached to the housing 20 of the razor cartridge 200.

The razor cartridge 200 may include a groove 7 extending longitudinally (i.e., parallel to one or more blades 5) across the razor cartridge 200 for receiving the shaving aid strip 3. In some examples, as depicted in FIGS. 2A-2C, a trailing portion 21 of the razor cartridge 200 configured to contact the skin of the user may include a groove 7 (e.g., a dovetail-shaped groove) into which the shaving aid strip 3 may be inserted. The shaving aid strip 3 may be configured to dovetail with the corresponding shape of the groove 7. In some examples, the shaving aid strip 3 may be dovetail-shaped and may be configured to couple with the corresponding shape of the groove 7. Thus, one of the shaving aid strip 3 and the groove 7 may be configured to dovetail with the corresponding shape of the other of the shaving aid strip 3 and the groove 7. The groove 7 may be located at a leading portion 22 of the razor cartridge 200 or any other suitable portion of razor cartridge 200. In some examples, multiple grooves 7 may be located in multiple portions of the razor cartridge 200.

In some examples, the attachment of the shaving aid strip 3 to the housing 20 of the razor cartridge 200 may include inserting one end of the shaving aid strip 3 into the groove 7. The shaving aid strip 3 may be slid into the groove 7 longitudinally across the groove 7 until the length of the shaving aid strip 3 is contained within the groove 7, coupling the shaving aid strip 3 with the housing 20 of the razor cartridge 200. A double arrow ‘S’ in FIG. 1 depicts the direction in which the shaving aid strip 3 may be slid along the razor cartridge 200. FIGS. 2B and 2E depict close-up, cross-sectional views of a portion A of the razor cartridge 200 from FIG. 2A with the shaving aid strip 3 inserted within the groove 7.

In some examples, e.g., the example of FIG. 2E, one or more of the upper longitudinal wall 30 and the lower longitudinal wall 31 of the groove 7 may include one or more protrusions 41, ridges, and/or other guide structures along which the shaving aid strip 3 may slide in order to facilitate insertion (or removal) of the shaving aid strip 3 into (or out of) the groove 7. In some examples, e.g., the example of FIG. 2E, the shaving aid strip 3 may be configured to include one or more corresponding ridges 40 or protrusions to promote sliding of the shaving aid strip 3 and/or to maintain positioning of the shaving aid strip 3 within the groove 7. In some examples, the groove 7 may include one or more ridges or protrusions to snap-fit or otherwise help to retain the shaving aid strip 3 within the groove 7 once the shaving aid strip 3 is fully inserted.

As depicted in FIGS. 2B and 2E, the portion of the shaving aid strip 3 that is contained within the groove 7 (3″ in FIGS. 2B, 2E) may have a shape that is complementary to the shape of the groove 7, and the groove 7 and the shaving aid strip 3 may dovetail one another. In some examples, the shaving aid strip 3 may have a male portion complementarily shaped with a female portion of the groove 7. In alternative examples, the groove 7 may have a male portion complementarily shaped with a female portion of the shaving aid strip 3. Thus, one of the shaving aid strip 3 and the groove 7 may have a male portion complementarily shaped with a female portion of the other of the shaving aid strip 3 and the groove 7.

In some examples, the complimentary shapes of the groove 7 and the shaving aid strip 3 may also help to maintain (e.g., via frictional interaction) the shaving aid strip 3 within the groove 7. For example, a cross-sectional shape of the groove 7 may taper inwards to create a narrowing of the groove 7 as the groove 7 opens out into the top surface of the housing 20 of the razor cartridge 200. The portion of the shaving aid strip 3 that fits within the groove 7 (3″ in FIGS. 2B, 2E) may also taper inwards to compliment the shape of the groove 7. In some examples, a portion of the shaving aid strip 3 configured to extend out of the groove 7 (3′ in FIGS. 2B, 2E) and onto the top surface of the housing 20 of the razor cartridge 200 to contact a user's skin may flare outwards. The inward taper of the groove 7 and a relatively-wider configuration of the shaving aid strip 3 may act to maintain the shaving aid strip 3 within the groove 7 when the shaving aid strip 3 is coupled with the housing 20 of the razor cartridge 200. Although a tapering shape is described, it is contemplated that the groove 7 and the shaving aid strip 3 may have any suitable complimentary shapes. In some examples, the groove 7 may be configured to include a male portion sized and shaped to match complementarily with a shaving aid strip 3 including a female portion.

In some examples, the groove 7 may be configured to hold the shaving aid strip 3 therein. In some examples, the complimentary shapes and/or dimensions of the groove 7 and the shaving aid strip 3 may act to hold the shaving aid strip 3 in place. For example, as described above, widening and tapering portions may collectively trap portions of the shaving aid strip 3 within the groove 7. In some examples, one or more of the upper longitudinal wall 30 and the lower longitudinal wall 31 of the groove 7 may be biased inwards to compress one or more of the upper longitudinal wall and the lower longitudinal wall of the groove or the shaving aid strip 3 to maintain the shaving aid strip 3 within the groove 7. In some examples, the groove 7 may include one or more protrusions and/or textured structures on a surface of one or more of the upper longitudinal wall 30 and the lower longitudinal wall 31 defining the groove 7.

In some examples, once the shaving aid strip 3 is inserted into the groove 7, the shaving aid strip 3 may be maintained in place within the groove 7 by one or more mechanical features. For example, in the embodiment of FIG. 2B, the groove 7 may be spring-loaded, and one or more springs 2 may be included within the razor cartridge 200 along one or more of the upper longitudinal wall 30 and the lower longitudinal wall 31 of the groove 7. Springs 2 may extend into the groove 7 to apply a force to the shaving aid strip 3. In some examples, one spring 2 may apply pressure to one side of the shaving aid strip 3, or, as is shown in FIG. 2B, two springs 2 may apply pressure to opposing sides of the shaving aid strip 3 to clamp the shaving aid strip 3 in place within the groove 7. In some examples, one or more springs 2 may apply pressure to one or more of the upper longitudinal wall 30 and the lower longitudinal wall 31 of the groove 7 so that one or more of the upper longitudinal wall 30 and the lower longitudinal wall 31 of the groove 7 clamp the shaving aid strip 3 in place within the groove 7. The springs 2 may be spring-loaded set screws and may hold the shaving aid strip 3 in position.

Instead of, or in addition to, the springs 2, one or more other features (e.g., projections) may be included within and/or around the groove 7 to perform a similar compression function. It is contemplated that such features may be integrally formed with one or more of the upper longitudinal wall 30 and the lower longitudinal wall 31 of the groove 7 and may be made of the same materials as the upper longitudinal wall 30 and the lower longitudinal wall 31 of the groove 7. The use of such features may help to retain the shaving aid strip 3 within the groove 7 and to make up for any spacing between the shaving aid strip 3 and the groove 7, e.g., due to the relative sizes or shapes of the shaving aid strip 3 and the groove 7 or to accommodate manufacturing tolerances or wear of the respective parts during use.

In some examples, alternative attachment features may also be used for maintaining the shaving aid strip 3 in place within the groove 7. For example, an alternative attachment mechanism may be based on the incorporation of particles with specific properties, such as magnetic particles or electrostatic particles, in the composition of the shaving aid strip 3. Additionally, one or more of the upper longitudinal wall 30 and the lower longitudinal wall 31 may be configured to activate the magnetic or electrostatic interactions between the shaving aid strip 3 and the walls 30, 31 of the groove 7. For example, one or more of the upper longitudinal wall 30 and the lower longitudinal wall 31 may be integrally formed with magnetic particles or electrostatic generators, such as rubber, glass, pith, or other materials that may act as insulators configured to generate charge in the surfaces of the upper and lower longitudinal walls 30, 31 under friction (e.g., during the insertion and/or removal motion of the shaving aid strip 3 to slide into the groove 7 and/or to slide out of the groove 7).

In other examples, an alternative attachment mechanism may be based on the chemical treatment of one or more sides of the shaving aid strip 3. In this context, the shaving aid strip 3 may include one or more sides configured to contact one or more of the upper longitudinal wall 30 and the lower longitudinal wall 31 of the groove 7. At least one of the sides of shaving aid strip 3 may be covered at least in part with an adhesive coating/layer. In some examples, one or more of the upper longitudinal wall 30 and the lower longitudinal wall 31 of the groove 7 may be modified superficially to include one or more adhesive spots, and the adhesive spots may be applied in small quantities (e.g., in droplets). Adhesive spots may allow for easier detachment of the shaving aid strip 3 from the groove 7 and replacement of the shaving aid strip 7 with a new one. In some examples, adhesive spots may be located at the one or more ends of the shaving aid strip 3 and/or the groove 7, so as to not inhibit the sliding motion of shaving aid strip 3 while functioning as a locking element to maintain the shaving aid strip 3 in place, once the total length of the shaving aid strip 3 is inserted into the groove 7.

According to some examples, one or more of the first side wall 26 or the second side wall 27 of housing 20 of razor cartridge 200 may include one or more auxiliary features configured to help maintain the shaving aid strip 3 within the groove 7. Particularly, auxiliary features may include a moveable flap, a cover, a lever, or a projection element configured to at least partially block the shaving aid strip 3 from exiting the groove 7. The auxiliary features may be arranged at an area where the groove 7 effectively traverses one or more of the first side wall 26 and the second side wall 27.

To use the replaceable shaving aid strip 3, the user may first slide off the old and/or worn shaving aid strip 3 by sliding the shaving aid strip 3 longitudinally out of the housing 20 of the razor cartridge 200. A replacement shaving aid strip 3 may be attached to the housing 20 of the razor cartridge 200 by inserting one end of the shaving aid strip 3 into the groove 7 from at least one of the first side wall 26 or the second side wall 27, depending on which one of the side walls the groove 7 traverses. Then, the shaving aid strip 3 may slide into the groove 7. As will be apparent to those of ordinary skill in the art, the shaving aid strip 3 may possess sufficient columnar rigidity to slide into and out of the groove 7. The shaving aid strip 3 may be slid until the shaving aid strip 3 snaps into place within the groove 7, until the end of the shaving aid strip 3 abuts the end of the groove 7, or until the shaving aid strip 3 has reached the opposite side of the housing 20 of the razor cartridge 200, for example. In some embodiments, the shaving aid strip 3 may include a gripping element, such as a tab, a rib, or a projection element, being arranged at one or more ends thereof to assist with the user grasping the shaving aid strip 3 and to facilitate removal of the shaving aid strip 3 from the groove 7.

The shaving aid strip 3 may be formed from a water-insoluble component, such as one or more rigid polymers that may provide a structural rigidity. In order to achieve lubricating properties or other skin-care benefits, the shaving aid strip 3 may also comprise water-insoluble ingredients and/or one or more cosmetic ingredients. Examples of rigid water-insoluble components include polystyrene, styrene co-polymers, polyethylene, polypropylene, polyacetal, acrylonitrile-butadiene-styrene copolymer, ethylene vinyl acetal copolymer, polylactic acid, polycarbonate, maleic anhydride ethylene co-polymer blends, polyether-containing block copolymers (e.g., with polyamide), and/or blends and copolymers of the above with or without other additives. Examples of water-soluble ingredients include polyethylene oxide and/or polyethylene glycol, polyvinyl pyrrolidone, polyacrylamide, polyhydroxymethacrylate, polyvinyl imidazoline, polyvinyl alcohol, polyhydromethymethacrylate, silicone polymers, and/or blends and copolymers of the above. One or more cosmetic ingredients may be used for achieving multiple skin-care benefits. As examples, cosmetic ingredients may include emulsifiers, surfactants, skin conditioners, fragrances, depilatory agents, cleaning agents, medicinal agents, cooling agents, anti-irritation agents, plasticizers, such as low molecular weight polyethylene glycols, water-swellable release enhancing agents, such as cross-linked polyacrylics and/or maleic anhydride compounds, additional lubricants, compatibilizers, and/or skin care agents selected from the group comprising vitamins, botanical extracts, salts, humectants, silicon oils, organic oils, waxes, antioxidants, exfoliants, anti-bacterial agents, anti-microbial, antiseptics, biocides, preservatives, skin soothing agents, hydrating agents, skin protectants, colorants, essential oils, film formers, processing thickening agents from the list of silica, fume silica, TiO₂ particles, and combinations thereof.

In some examples, the shaving aid strip 3 may include a male portion 3″ (FIGS. 2B, 2E) to be contained within the groove 7, and the male portion 3″ may be formed of the same or of different material as the upper portion 3′ (FIGS. 2B, 2E) of the shaving aid strip 3 that may be configured to extend from the groove 7 so as to contact the skin of the user. In some examples, the shaving aid strip 3 may include an abrasive (e.g., exfoliating) surface, including, e.g., exfoliating beads, patterns, textures and/or or other suitable materials. In some embodiments, the shaving aid strip 3 may include a low-friction surface comprising a hydrophilic coating for achieving improved glideness.

Because the shaving aid strip 3 is removable, users may be able to customize their shaver and/or razor cartridge specifically to their needs via use of one or more shaving aid strips 3. For example, users may be able to customize their razor cartridge 200 by selecting shaving aid strips 3 with different ingredients according to their needs and the skin care benefits they expect to achieve.

In some examples, the shaving aid strips 3 may be designed for users just learning how to shave. For example, the shaving aid strips 3 for novice users may include extra lubrication or may provide additional cushioning or different-shaped profiles to make it more difficult to hurt the skin. The shaving aid strips 3 may be designed to accommodate use on different parts of the body (e.g., face, neck, armpits, legs, etc.) and/or differences in use by gender. In some examples, use of the shaving aid strip(s) 3 may allow a user to customize the razor cartridge 200 to make the shaver 100 more ergonomic and/or to help users with a limited range of motion (e.g., disabilities). The size and/or shape of the shaving aid strip(s) 3 may be used to alter the shaving geometry (e.g., exposure) of the razor cartridge 200. Altering the shaving geometry may facilitate use by inexperienced users, use on different parts of the body, use by different grip styles or hand size of a user, and/or different physical limitations or needs of a user. A shaving aid strip 3 with different geometries and profiles may also allow a user to leave more or less hair behind when shaving, for example, to achieve a clean shave versus stubble.

According to some examples, users may be able to customize their shavers with preferred moisturizing and/or lubricating ingredients, fragrances, essential oils, or any other suitable materials. Users may also be able to customize their shavers 100 with different sized shaving aid strips 3 (e.g., wider or narrower or protruding more or less out past the upper longitudinal wall 30 and the lower longitudinal wall 31 of the groove 7). Users may also be able to select different colored shaving aid strips 3, and/or shaving aid strips 3 with different patterns, graphics, and/or text that are embossed, imprinted, or otherwise included thereon.

Users may change the shaving aid strips 3 daily, weekly, or monthly, for example, to suit their needs. In some examples, the housing 20 of the razor cartridge 200 may include multiple grooves 7 for attaching multiple shaving aid strips 3 at once to the razor cartridge 200, allowing users to use multiple of the same shaving aid strips 3 at once, or allowing a user to use combinations of different shaving aid strips 3 at once. In some examples, inactive shaving aid strips 3 may be available to simply fill in the groove 7 if no shaving aid strip 3 is desired, or, in examples with multiple grooves 7, if only one shaving aid strip 3 is desired.

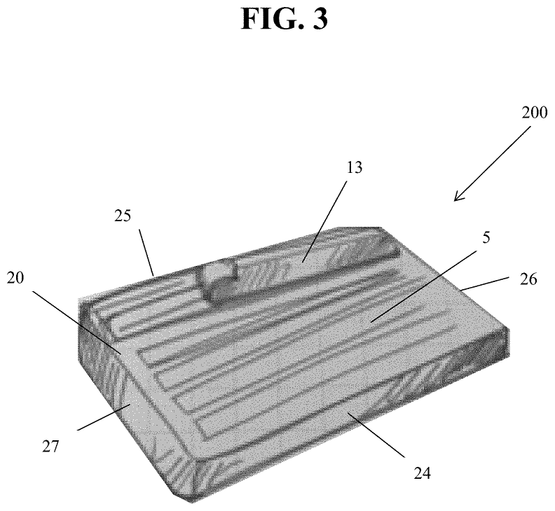

In some examples, for further extending the useful lifetime of the shaving aid strip 3 per se (even though shaving aid strip 3 may be temporary) before removal and replacement, an alternative type of shaving aid strips may be used in addition to the shaving aid strips as described herein. This alternative type of shaving aid strip may be adhesive strip 13. FIG. 3 depicts a shaving aid adhesive strip 13 applied on the housing 20 so as to function as sticky tape. One or more shaving aid adhesive strips 13 may be applied/stuck as sticky tapes/films on a top surface of the upper portion of, e.g., the herein disclosed shaving aid strips. In this context, the shaving aid adhesive strips 13 may provide an additional layer of skin care composition (e.g., lubricating, moisturizing, etc.) on the top surface of the upper portion of the underlying replaceable shaving aid strip, and this top composition may be the same as or different than the composition of the shaving aid strip. In some examples, the shaving aid adhesive strips 13 may be used independently of the herein disclosed shaving aid strips, i.e., the shaving aid adhesive strips 13 may be applied/stuck as a sticky tape/film directly on the top surface of the housing 20 beyond the groove 7. In some examples, the user may purchase a pack with several shaving aid adhesive strips 13 for applying them on the used, replaceable shaving aid strips, according to the aspects of this disclosure, or for applying them on the top surface of the housing 20 beyond the groove 7, directly. In this context, the shaving aid adhesive strips 13 may renew the lubricating elements of the razor cartridge 200.

In some examples, use of replaceable shaving aid strips 3 may allow a user to extend the life of their shaver 100 and/or the razor cartridge 200. As discussed before, the shaving aid strip 3 may wear out before the blades 5 dull. Accordingly, the user may either change the razor cartridge 200 prematurely, wasting the blades 5 that are still sufficiently sharp to cut hair, or may wait to change the razor cartridge 200 until the blades 5 are dull, which may result in a suboptimal shaving experience, since the shaving aid strip 3 may no longer be capable of performing its intended function, or may function at a lower level. These may result either in additional waste and/or a substandard shaving experiences for the user. Replacing only the components of the razor cartridge 200 that need to be replaced (e.g., the shaving aid strip 3), may allow a user to extend the life of the razor cartridge 200 and/or the shaver 100, while also allowing for more customization of the razor cartridge 200. Additionally, replacing the shaving aid strip 3 regularly may prolong the life of the blades 5 by ensuring that the blades 5 have proper lubrication. In turn, the value of the shaver and/or the handle may be increased by promoting longer use, particularly since the shaving aid strips 3 may be used in conjunction with shavers including disposable razor cartridges or shavers including fixed razor cartridges 200.

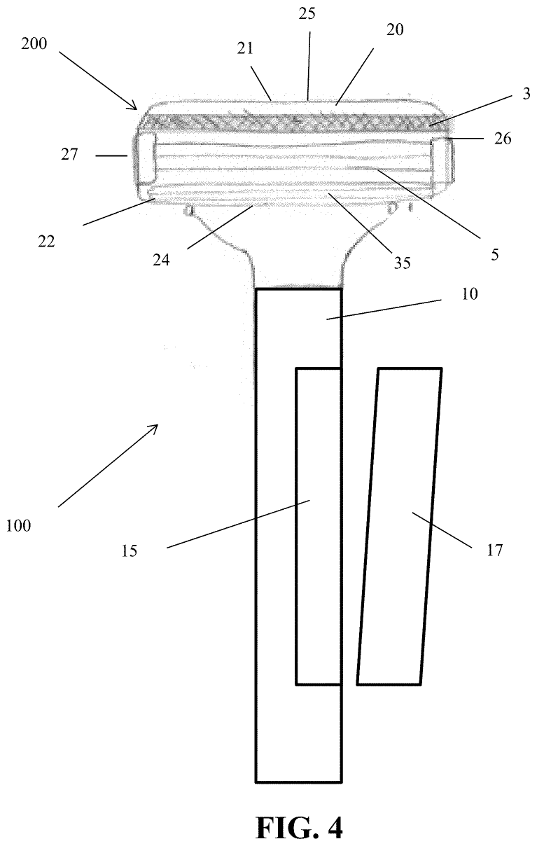

When not in use, extra replacement shaving aid strips 3 may be stored separately from the shaver 100 or may be stored within the shaver 100, for example, within the handle 10. FIG. 4 depicts a shaver 100 having a handle 10 that includes a compartment 15 located within the handle 10. A cover 17 may seal off the compartment 15 during use or storage of the shaver 100 to enclose replacement shaving aid strips 3 when not needed. The cover 17 may then be removed (depicted in FIG. 4) to reveal the underlying compartment 15 and to allow a user to store and/or access the shaving aid strips 3 stored within the compartment 15. Accordingly, the handle 10 may include a hollow, inner portion, and the shaving aid strips 3 may be stored within the handle 10 until a user is ready to replace an existing shaving aid strip 3 of the razor cartridge 200 with a new shaving aid strip 3. In such examples, a portion of the handle 10 may be removed or otherwise opened in order to access new shaving aid strips 3 (as is shown in FIG. 4) or a portion of the handle 10 may unscrew (e.g., an end portion of the handle 10 may screw off or may include a hinged flip endcap). The portion of the handle 10 removed or opened may remain at least partially attached (e.g., via one or more hinges) or may be completely removed. The portion removed may include a watertight and/or airtight seal (e.g., to inhibit mold or mildew growth within) and may snap, screw, friction fit, pivot, slide, rotate, or otherwise move into and out of position to cover compartment 15.

To use a replaceable shaving aid strip 3, the user may first select the desired strip. If a shaving aid strip 3 is already included in the razor cartridge 200 (whether worn or new), it may first be removed from the housing 20 of the razor cartridge 200 by sliding the strip in a longitudinal direction out of the groove 7. Once removed, the old shaving aid strip 3 may be discarded or saved for future use. The new shaving aid strip 3 may be removed from packaging and/or removed from within a storage portion of shaver 100 (e.g., the compartment 15 in the handle 10).

Removal and/or replacement of the shaving aid strip 3 may occur while the razor cartridge 200 is attached to the handle 10 or prior to attachment of the razor cartridge 200 to the handle 10. In some examples, once the shaving aid strip 3 is in place, a user may expose the razor cartridge 200 and the new shaving aid strip 3 to water to prepare the new shaving aid strip 3 for use, in case the shaving aid strip 3 comprises water-activated ingredients.

The many features and advantages of the present disclosure are apparent from the detailed specification, and thus, it is intended by the appended claims to cover all such features and advantages of the present disclosure that fall within the true spirit and scope of the disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

Moreover, those skilled in the art will appreciate that the conception upon which this disclosure is based may readily be used as a basis for designing other structures, methods, and systems for carrying out the several purposes of the present disclosure. Accordingly, the claims are not to be considered as limited by the foregoing description.

What is claimed is:

1. A razor cartridge comprising:
a housing having a top surface, a bottom surface, a first side wall, and a second side wall;
one or more blades disposed within the housing;
a groove extending along or parallel to a longitudinal axis of the razor cartridge, the groove being located on the top surface, extending between the first side wall and the second side wall and traversing one or more of the first side wall and the second side wall; and
a shaving aid strip configured to be releasably coupled with the groove by sliding the shaving aid strip into and out of the groove.

2. The razor cartridge of claim 1, wherein one of the shaving aid strip and the groove has a male portion complementarily shaped with a female portion of the other of the shaving aid strip and the groove, so that the male portion and the female portion are configured to frictionally interact with each other.

3. The razor cartridge of claim 1, wherein one of the shaving aid strip and the groove is configured to dovetail with a corresponding shape of the other of the shaving aid strip and the groove.

4. The razor cartridge of claim 1, wherein the groove further comprises an upper longitudinal wall and a lower longitudinal wall, wherein one or more springs are configured to compress one or more of the upper longitudinal wall and the lower longitudinal wall of the groove to maintain the shaving aid strip within the groove.

5. The razor cartridge of claim 1, wherein the groove further comprises one or more ridges or protrusions extending along one or more of the upper longitudinal wall and the lower longitudinal wall of the groove.

6. The razor cartridge of claim 1, wherein the shaving aid strip includes a gripping element selected from the group consisting of a tab, a rib, and a projection element, the gripping element being arranged at one or more ends of the shaving aid strip to assist a user with grasping the shaving aid strip.

7. The razor cartridge of claim 1, wherein the shaving aid strip comprises one or more sides configured to contact with one or more of the upper longitudinal wall and the lower longitudinal wall of the groove, at least one of the sides being covered at least in part with an adhesive coating.

8. The razor cartridge of claim 1, wherein one or more of the upper longitudinal wall and the lower longitudinal wall include one or more adhesive spots.

9. The razor cartridge of claim 1, wherein one or more of the upper longitudinal wall and the lower longitudinal wall has a tapering portion for holding the shaving aid strip within the groove.

10. The razor cartridge of claim 1, wherein one or more of the first side wall and the second side wall of the housing comprises one or more auxiliary features selected from the group consisting of a movable flap, a cover, a lever, and a projection element, the auxiliary features being configured to maintain the shaving aid strip within the groove.

11. The razor cartridge of claim 10, wherein the auxiliary features are located at an area where the groove effectively traverses one or more of the first side wall and the second side wall.

12. The razor cartridge of claim 1, wherein the shaving aid strip includes magnetic or electrostatic particles, and the groove is configured to activate magnetic or electrostatic interaction with the shaving aid strip.

13. A shaver having a razor cartridge, wherein the razor cartridge comprises:
a housing having a top surface, a bottom surface, a first side wall, and a second side wall;
one or more blades disposed within the housing;
a groove extending along or parallel to a longitudinal axis of the razor cartridge, the groove being located on the top surface, extending between the first side wall and the second side wall, and traversing one or more of the first side wall and the second side wall;
a shaving aid strip configured to be releasably coupled with the groove by sliding the shaving aid strip into and out of the groove; and
a handle connected to the razor cartridge.

14. The shaver of claim 13, wherein the handle comprises an interior compartment configured to contain one or more shaving aid strips.
